(19) United States
(12) Patent Application Publication
(10) Pub. No.: US 2007/0222808 A1
(43) Pub. Date: Sep. 27, 2007

(54) Test Device for an Ink Cartridge

(76) Inventors: Alfred Gass, Sissach (CH); Roger Suter, Steffisburg (CH); Daniel Blattler, Uttigen (CH)

Correspondence Address: WELSH & KATZ, LTD, 120 S RIVERSIDE PLAZA, 22ND FLOOR, CHICAGO, IL, 60606, US

(21) Appl. No.: 10/593,805

(22) PCT Filed: Mar. 24, 2005
(86) PCT No.: PCT/CH05/00171

§ 371 Date: Sep. 21, 2006

(30) Foreign Application Priority Data
Mar. 24, 2004 (EP) 04405183.7

(51) Int. Cl. B41J 29/393

(52) U.S. Cl. 347/19

(57) ABSTRACT

A test device for an ink cartridge comprises means (6) for supplying ink from the ink cartridge to a strip of paper. The device is embodied in such a way that the means for supplying ink from the ink cartridge can also supply ink off (10) the strip of paper. One such test device enables the paper consumption to be reduced, a drive of the strip of paper to be maintained, and the energy consumption thereof to be reduced.

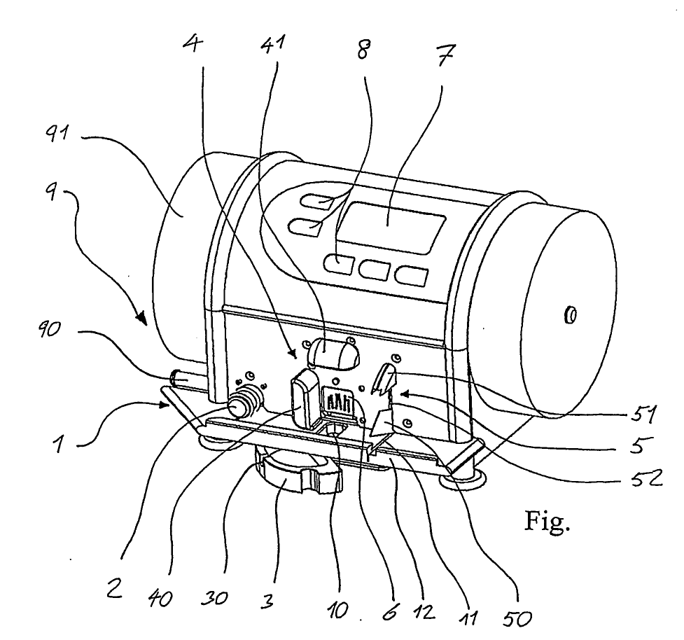

### FIELD OF INVENTION

The invention relates to a test device for an ink cartridge.

### BACKGROUND

Ink cartridges, for which such test devices are provided, are used, for example, in ink jet printers for the printing of paper. Typically, they have an integrated print head, which comprises electric contacts, nozzles, and a microchip. The nozzles can be controlled via the electric contacts in the ink jet printer.

When, after a certain operating period, the ink in an ink cartridge is exhausted, the ink cartridge is typically disposed of or replaced with a new ink cartridge, which is very cost-intensive, or it is recycled. When recycling, the ink cartridge can, for example, be tested first for its electric functional efficiency with the above-mentioned test device. For this purpose, the empty ink cartridge is positioned in the test device and all of the contacts of the ink cartridge are tested individually. The test result can be illustrated in a display window of the test device, for example.

With a positive test result, the ink cartridge can be removed from the test device and can be processed. In particular, it can be refilled with ink. After the processing, the ink cartridge is finally checked in the test device. For this purpose, it is once again positioned and its electric functional efficiency is once again checked. Thereafter, a cleaning print, for example, is generated on the strip of paper, which runs through below the positioned ink cartridge. For this purpose, the test device comprises a holder for a roll of strips of paper, a paper run, and a drive for transporting the strip of paper on the paper run. The cleaning printout can be carried out in a print-specific and/or cartridge-specific manner and effects the activation and rinsing of the nozzles. Air bubbles, for example, are removed therewith from the nozzles, which could prevent a clean printing. After the cleaning printout, the test device typically generates a test print, from which the print characteristics of the ink cartridge and, in particular, of its nozzles, are apparent. The two printouts (the cleaning printout and the test printout) can be produced several times one after another in the test device, until a reliable decision regarding the condition of the ink cartridge is possible.

The testing of recycled ink cartridges in such test devices, as compared to a testing in the ink jet printers, can be carried out in an extremely speedy and effortless manner. A plurality of types of ink cartridges can also be checked in a single test device. Furthermore, such test devices, in particular the positioning means of the ink cartridges, are embodied in an extremely robust manner and are thus suitable for testing large amounts of ink cartridges. However, when generating the cleaning printout, where a relatively large amount of ink is printed, long strips of paper without information content are produced. Consequently, the roll of the strips of paper must be changed relatively frequently, the paper is exhausted without utilizable value, and the drive is strained relatively often and for a long period of time, thus wearing more rapidly and also consuming relatively high amounts of energy.

It is thus the object of the following invention to propose a test device for an ink cartridge, which avoids the disadvantages of the above-described test devices.

### SUMMARY

In particular, the test device comprises means for supplying ink from the ink cartridge to a strip of paper. The test device is embodied in such a way that the means for supplying ink from the ink cartridge can also supply ink off the strip of paper. A printout can be generated on the strip of paper, as well as next to the strip of paper, quasi as a “virtual” printout. A printout without utilizable information, for example a cleaning printout, can thus be generated, without exhausting the paper and without a drive having to transport paper. On the one hand, the paper consumption can be reduced with such a test device and, on the other hand, the drive can be conserved and its energy consumption can be decreased. Furthermore, with a virtual printout it can be freely determined, which nozzle is to supply what amount of ink at what point in time.

Preferably, the test device comprises a container for collecting ink supplied off the strip of paper. Ink supplied during a virtual print can thus be collected and discharged.

In a preferred variant of embodiment, an absorbent, replaceable medium, for example an absorbent web material, is arranged in the container. Such a medium prevents that thereby the ink supplied into the container splatters and that other parts of the test device or other things, such as, for example, the base of the test device, are soiled. After a certain operating period or after a certain amount of virtual printouts, the absorbent medium can be replaced, so that an overflow of the container can be prevented. With an absorbent medium it is also prevented that ink supplied into the container dries and that the container must be cleaned extensively.

The test device can comprise a strip of paper run and positioning means for positioning the ink cartridge above the strip of paper run. Ink cartridges, which are to be tested by the test device, can be accurately and speedily positioned with such positioning means. They can be embodied in an extremely robust manner for a frequent positioning and removal of ink cartridges of one or a plurality of certain types. A strip of paper can be transported in a controlled manner in a predefined path on the strip of paper run.

Advantageously, the test device comprises a bidirectional drive, which transports the strip of paper on the strip of paper run forward and backward. Such a drive can transport a strip of paper on the strip of paper run in both possible strip run directions.

The bidirectional drive, viewed in forward running direction of the strip of paper, can be arranged in front of the positioning means. This ensures a simple transporting of the strip of paper on the strip of paper run and makes it possible that the strip of paper can be pulled backward as far as in front of the positioning means.

The test device preferably comprises cutting means for cutting the strip of paper. The strip of paper can be automatically cut through with such cutting means, for example after completion of a printout.

The cutting means, viewed in forward running direction of the strip of paper, can be arranged after the positioning means, which allows for a simple configuration of the cutting means.

In a preferred variant of embodiment, the strip of paper run has a continuous opening located below the positioning means. The container is arranged below the opening in a swivellable and detachable manner. For supplying ink off the strip of paper, the ink can be supplied directly into the container through the opening, without moving the ink cartridge. The swiveled or detached container can be cleaned in simple manner.

### BRIEF DESCRIPTION OF THE DRAWINGS

Further advantageous embodiments of the invention result from the following description of an exemplary embodiment of the invention, with the help of the schematic drawing, which shows a perspective front view of an exemplary embodiment of a test device according to the invention.

### DETAILED DESCRIPTION

The test device comprises a hinged housing and positioning means 4 arranged at the front of the housing. The positioning means 4 have a clamping device 41, a first vertically arranged positioning beam 40, and a second vertically arranged positioning beam (not shown in the figure). A perforated sheet 6 is arranged below the clamping device 41 at the front of the housing and a print head control unit (not visible in the figure) is arranged behind the perforated sheet 6, on the inside of the housing.

At the left side of the housing, the test device has a paper supply 9, which comprises a roll holder 91 and a guide roller 90. A strip of paper run 1 is horizontally arranged below the positioning means 4, along the front of the housing. The strip of paper run 1 has an edge 12 on the longitudinal side facing away from the housing and is equipped with a continuous opening 10 below the clamping device 41 and the perforated sheet 6. A swivellable and detachable dish 3 is arranged below the opening 10 as a container. The edge of the dish 3 has a spillway 30 opened vertically upwards.

Between the left side of the housing and the first positioning beam 40, a cylindrical drive shaft 2 is arranged, which projects perpendicularly forward from the front of the housing and extends transversely across the strip of paper run 1. Between the second positioning beam (not shown in the figure) and the right side of the housing, cutting means 5 are arranged at the front of the housing. The cutting means comprise a knife 50, extending transversely across the strip of paper run 1, and a guide slit 52. Above the cutting means 5, the test device comprises a protective cap 51. A groove 11 into which the knife 50 can dip and which adjoins the lower end of the guide slit 52, extends transversely through the strip of paper run 1 (including the edge 12). Operating keys 8 and a display 7 are arranged at the upper part of the front of the housing.

For testing an ink cartridge, the ink cartridge is clamped between the first positioning beam 40 and the second positioning beam by means of the clamping device 41 in such a way that the electric contacts of the print head come to rest directly in front of the perforated sheet 6 and the nozzles of the print head are directed against the opening 10.

In the roll holder 91, a roll of strip of paper is arranged, which is manually guided through below the guide roller 90 to the strip of paper run 1 and pushed between the strip of paper run 1 and the drive shaft 2. The drive shaft 2 supplies the strip of paper on the strip of paper run 1 further below through the first positioning beam 40, the print head of the clamped ink cartridge, the second positioning beam, and the knife 50. The lower edge of the first positioning beam 40 is thereby embodied in such a way that the gap between the strip of paper run 1 and the first positioning beam 40 is expanded in the direction of the drive shaft 2. This enables a simple and reliable insertion of the strip of paper into this gap.

During a test print, the individual nozzles of the ink cartridge are specifically controlled by the print head control unit through the perforated sheet 6, for example, by means of contact pins, and the ink is supplied to the strip of paper controlled by the drive shaft 2. By means of such a test print, a statement regarding the functional efficiency of the ink cartridge can be made.

For performing a virtual printout, such as a cleaning print, for example, the knife 50 is guided along the guide slit 52 into the groove 11 of the strip of paper run 1 in advance, and the strip of paper is cut therewith. Thereafter, the rotational direction of the drive shaft 2 is changed and the strip of paper is pulled back until the opening 10 is exposed. The nozzles in the print head of the ink cartridge are then controlled by the print head control unit through the perforated sheet 6 in a predetermined manner, by means of contact pins, for example, and a respective predetermined amount of ink is supplied through the opening 10 into the dish 3. If the supply of the ink is concluded, the strip of paper is again transported forward through the drive shaft 2 below the ink cartridge, the second positioning beam, and the reset knife 50. In this condition, the test device is again ready to print strips of paper.

The dish must be emptied and cleaned after a certain amount of virtual printouts, which can be done manually, when the dish is swung out or detached, or in an automated manner, for example via a suction hose. The spillway 30 prevents an uncontrolled leakage of the ink supplied into the dish 3. To prevent splattering during the supply of the ink into the dish 3, an absorbent web material can also be arranged in the dish as absorbent medium, which is replaced from time to time, when it is largely saturated with ink.

Inputs necessary for a test can be made via the operating keys 8 and different actions of the test device can be started. The display 7 displays different information, such as, for example, electric measurements, which were determined during the checking of the individual electric contacts of the ink cartridge and which can be used for evaluating the electric functional efficiency of the ink cartridge.

Specific embodiments of a Test Device for an Ink Cartridge according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

1. Test device for an ink cartridge, comprising means for supplying ink from the ink cartridge to a strip of paper, wherein the means for supplying ink from the ink cartridge can also supply ink off the strip of paper.

2. Test device according to claim 1, comprising a container for collecting ink supplied off the strip of paper.

3. Test device according to claim 2, wherein an absorbent, replaceable medium, for example an absorbent web material, is arranged in the container.

4. Test device according to claim 1, further including a strip of paper run and positioning means for positioning the ink cartridge above the strip of paper run.

5. Test device according to claim 4, which comprises a bidirectional drive, which transports the strip of paper on the strip of paper run forward and backward.

6. Test device according to claim 5, wherein the bidirectional drive, viewed in forward running direction of the strip of paper, is arranged in front of the positioning means.

7. Test device according to claim 1, further including cutting means for cutting the strip of paper.

8. Test device according to claim 4, wherein the cutting means, viewed in forward running direction of the strip of paper, are arranged behind the positioning means.

9. Test device according to claim 2, wherein the strip of paper run comprises a continuous opening below the positioning means, below which the container is swivellably and detachably arranged.
